(19) United States
(12) Patent Application Publication
(10) Pub. No.: US 2003/0076671 A1
(43) Pub. Date: Apr. 24, 2003

(54) Insulated beverage glow cup

(76) Inventor: Darlene Diak/Ghanem, Boca Raton, FL (US)

Correspondence Address: Darlene Diak/Ghanem, 299 NE Spanish Trail, Boca Raton, FL, 33432, US

(21) Appl. No.: 10/000,826

(22) Filed: Oct. 24, 2001

(51) Int. Cl. F21V 33/00

(52) U.S. Cl. 362/101; 362/84; 250/462.1

(57) ABSTRACT

An insulated drinking cup containing evenly-spaced embedded circumferential bands of light-absorbing luminescent material positioned at regular intervals. In the preferred embodiment, the insulated drinking cup is formed from a transparent material consisting of an inner and outer wall that forms an airspace which insulates the contents of the cup. The bands of luminescent material are disposed in the insulating airspace. The bands of luminescent material illuminate the drinking cup in the dark, and make it possible to determine the level of liquid in the cup.

### BACKGROUND OF THE INVENTION

This invention relates to an insulated glow cup and more particularly, an insulated cup that will reduce condensation from forming on the outside of the vessel. The design of the cup incorporates an inner liner and outer annular shell. There are bands of luminescent material placed on the inner liner that enable the cup to be seen in the dark.

### DESCRIPTION OF THE PRIOR ART

U.S. Pat. No. 5,609,409 issued Mar. 11, 1997 To Diehl discloses a stemmed drinking glass with an upper cup supported by a hallow stem and connected to a base that uses a chemiluminescent light stick inserted into the hollow stem to provide illumination.

U.S. Pat. No. 5,807,156 issued Sep. 15, 1998 to Owen discloses an attachment for baby bottles, which include designs of luminescent material, which enables the baby bottle to be seen in the dark. In one embodiment, the attachment has double walls, with the luminescent material placed between the walls. In another embodiment, the luminescent material is affixed to the outside surface of the attachment. U.S. Pat. No. 4,563,726 issued Jan. 8, 1986 to Newcomb et al discloses a mug having a compartment for receiving a glow stick. The compartments are accessible, thus, allowing the glow stick to be removed and replaced.

U.S. Pat. No. 6,062,380 issued May 16, 2000 to Dorney discloses a deformable plastic drinking glass having chemiluminescent chemicals contained in separate compartments within the glass. When a user deforms the glass by hand the chemicals are mixed, and the drinking glasses are illuminated.

In the above-mentioned prior art, directs to “glowing” beverage containers all utilizing a chemiluminescent light source, which produces light when the two light.

### SUMMARY OF THE INVENTION

The present invention pertains to an insulated glow cup apparatus. As such, the general purpose of the present invention is to provide a new insulated glow cup apparatus that has all the advantages of the prior art and none of the disadvantages. To achieve this, the present invention essentially comprises of a first smooth conical shaped outer wall, there are bands of luminescent material that are disposed on the inner wall forming an airspace between the walls, helping to reduce outer wall condensation. It is an objective of the present invention to provide a new insulated glow cup for beverages, in which the insulated capabilities of the vessel will maintain the liquids temperature for a longer period of time as compared to a non-insulated cup. It is yet another objective of the present invention that with the cups illumination capabilities enable the vessel to glow in the dark, allowing the user to determine the amount of liquid that is in the cup in a low light level environment. It is further an objective of the invention to teach the use of a insulated glow sip cup with a screw lid attachment, with a valve attachment to the cap, for prevention of spills. These and other objects and advantages of the present invention will become apparent from the following description, when read in conjunction with the accompanying drawings.

### BRIEF DESCRIPTION OF THE FIGURES

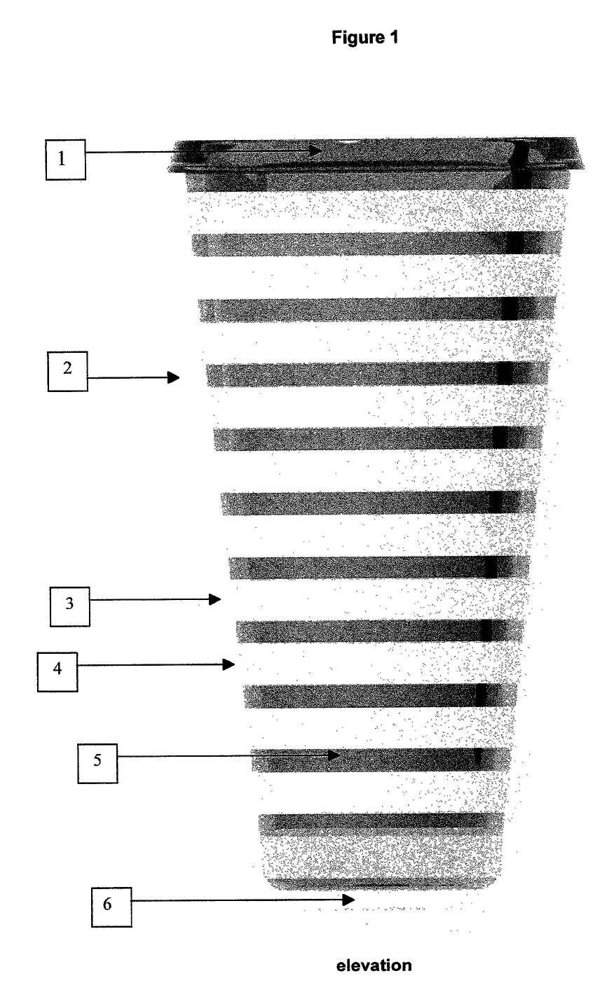

1. FIG. 1 illustrates a elevation view of the insulated beverage glow cup;

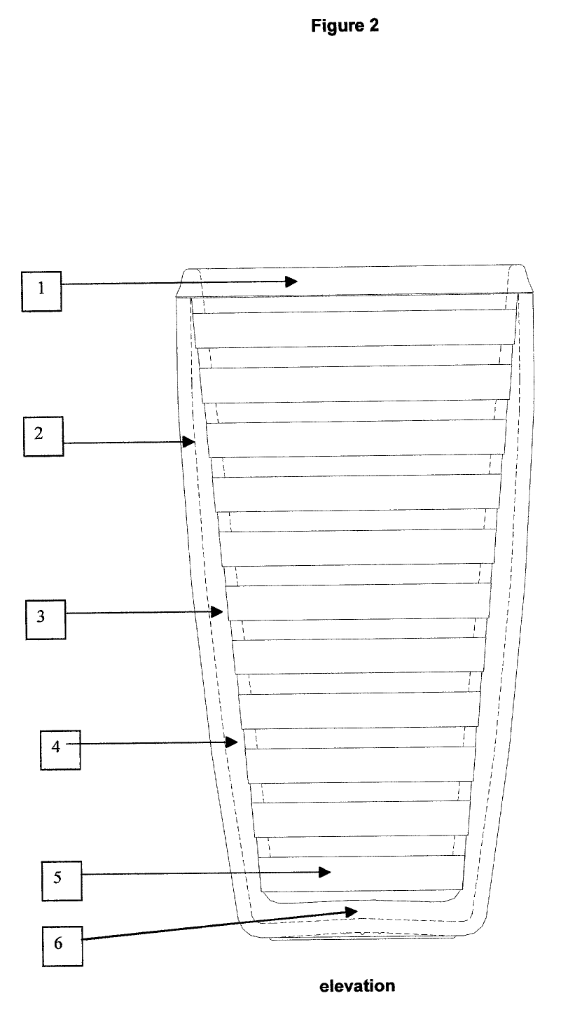

2. FIG. 2 illustrates an exploded perspective view of the insulated beverage glow cup of this invention;

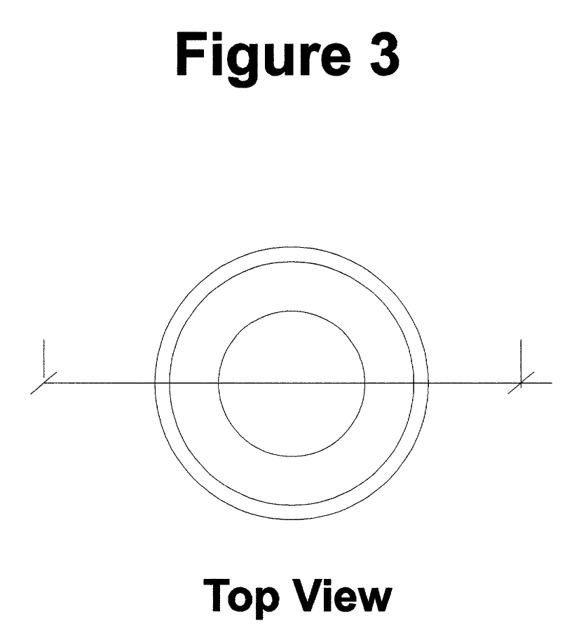

3. FIG. 3 illustrates a top view of FIGS. 1 and 2

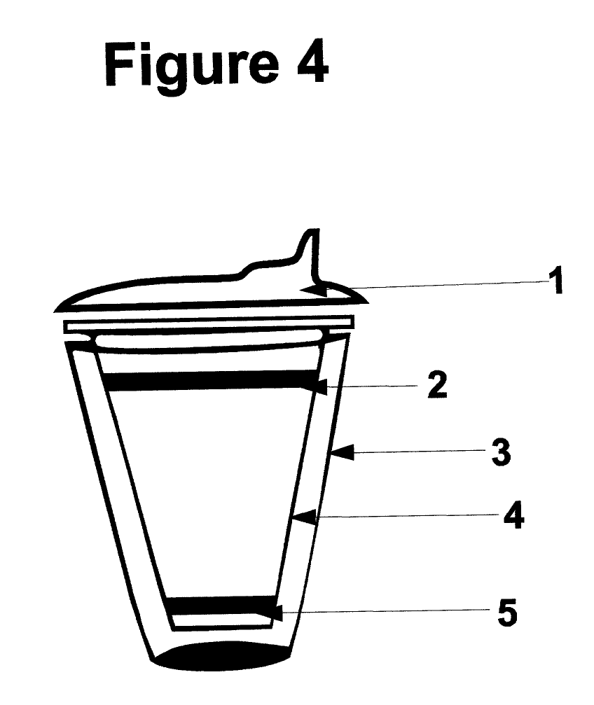

4. FIG. 4 illustrates an elevation view of the insulated glow sip cup with a lid attachment.

### DETAILED DESCRIPTION OF THE EMBODIMENT

The present invention pertains to an insulated beverage glow cup, now referring to FIGS. 1 to 4 of the vessel. FIG. 1 illustrates an insulated beverage glow cup constructed according to the invention. The cup is comprised of a bottom 6, an outer generally cylindrical wall 2 that includes an inner cylindrical shaped wall 4, an airspace 3 that is formed between the inner and outer wall, and a top 1 formed from a transparent material. The cup further comprises bands of luminescent material 5. The outer cylindrical wall 2 has an upper end, and the inner cylindrical wall 4 has an upper end, that is adhesively secured to the top 1. Outer cylindrical wall 2 is a smooth surfaced structure telescoped onto inner cylindrical wall 4 so as to engage end areas of the inner wall. Airspace 3 is interposed between the inner and outer wall, and extends entirely around inner wall 4. The airspace provides insulation capabilities, in which will maintain the liquids temperature for a longer period of time. The bands of luminescent material 5 are disposed in the insulating airspace, between the inner wall and outer wall, to provide illumination capabilities that enable the vessel to glow in the dark, or allowing the user to determine the amount of liquid that is in the cup in a low light level environment.

What is claimed is:

1. An insulated glow cup apparatus comprising, consisting of:
A conical shaped inner wall having an upper and lower end.
A conical shaped outer wall having an upper and lower end.
The conical shaped outer shell is telescoped onto the inner shell.
The inner and outer shell consists of a circular rounded bottom.

2. The inner and outer shells of the apparatus are bonded together, forming an airtight seal.

3. In the preferred embodiment, the inner and outer walls create an internal airspace. This airspace helps insulate the contents of the cup from higher external temperatures.

4. In the preferred embodiment, the drinking cup is formed from a transparent material.

5. In the preferred embodiment, there are evenly spaced bands of light-absorbing luminescent material positioned at regular intervals.
